(19) United States
(12) Patent Application Publication
(10) Pub. No.: US 2010/0169326 A1
(43) Pub. Date: Jul. 1, 2010

(54) METHOD, APPARATUS AND COMPUTER PROGRAM PRODUCT FOR PROVIDING ANALYSIS AND VISUALIZATION OF CONTENT ITEMS ASSOCIATION

(75) Inventors: Jian Ma, Beijing (CN); Xiaogang Yang, Beijing (CN); Canfeng Chen, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/347,764

(22) Filed: Dec. 31, 2008

(51) Int. Cl. G06F 17/30; G06T 11/20

(52) U.S. Cl. 707/749; 707/E17.014

(57) ABSTRACT

An apparatus for providing analysis and visualization of content items associations may include a processor that may be configured to perform an analysis of a link relation between a source content item and at least one of a plurality of content items. The processor may further be configured to identify at least one content item relevant to the source content item by identifying a similarity between at least one attribute associated with the source content item and at least one attribute associated with the at least one relevant content item. The processor may also be configured to determine a weight of the link relation based at least in part on the identified similarity, and provide for display of a link relation between the source content item and the identified at least one relevant content item. A corresponding method and computer program product may also be provided.

### TECHNOLOGICAL FIELD

Embodiments of the present invention relate generally to communication interface technology and, more particularly, relate to a method, apparatus, and computer program product for providing analysis and visualization of content items associations.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer to and between users and other entities. One area in which there is a demand to increase ease of information transfer relates to the capture and organization of information in a manner that is comprehensible to the user. In this regard, many mobile terminals now include various devices or means (e.g., digital camera) for capturing and/or generating, modifying, storing, retrieving, and/or sharing digital media (e.g., digital images). Similarly, current networking technologies provide systems for storing, modifying, retrieving and/or sharing digital media (e.g., digital images). Many mobile terminals are also enabled with access to information via the Internet or other networking systems. In this regard, mobile terminals may be used to access the networking systems to upload digital images stored on the mobile device to the networking systems and retrieve digital media from the networking systems. Additionally, the user and/or the networking systems may associate one or more metadata with the digital media such as, for example, a name, narrative, annotation, information about the size, type (e.g., data type), and date of creation.

Although existing technologies may allow the capture, storing, retrieving, and/or sharing of digital media over the Internet or other networking systems, it is generally desirable to continue improvement of existing technologies.

### BRIEF SUMMARY

A method, apparatus and computer program product are therefore provided for providing analysis and visualization of content items associations. In particular, a method, apparatus and computer program product are provided that create a mechanism for enabling the analysis and visualization of a link relation between at least two content items (e.g., media such as images, multimedia, and/or the like). The content items may be stored on a memory device (e.g., a database) that may store a plurality of other content items. The database may also store attributes (e.g., metadata) associated with the content items such as, for example, time, location, storage information, and/or the like. Thus, for example, the content items may be organized and managed based at least in part on their attributes. As such, a link relation may exist between at least two content items based at least in part on the similarities of their respective attributes (e.g., one or more same or similar respective attributes). Accordingly, at least two content items may be connected with each other based at least in part on the similarity of their respective attributes. In this regard, exemplary embodiments of the present invention take into consideration one or more different types of attributes (e.g., embedded metadata) associated with at least two content items, and build a link relation (and a corresponding weight of the link relation) between at least two content items stored in a memory device.

A method, apparatus and computer program product may thus be provided that create a mechanism for enabling the analysis and visualization of a link relation between at least two content items in a database based at least in part on the similarities of their respective attributes. Accordingly, a link relation analysis may be performed between a source content item selected by a user and one or more content items to identify one or more content items relevant or otherwise related to the source content item based at least in part on the similarities (e.g., one or more same or similar attributes, generally referred to similar attributes) between the respective attributes of the source content item and the one or more content items. One or more relevant content items (e.g., from a plurality of content items) may be automatically identified and retrieved based at least in part on the analysis of the link relation. A visualization of the link relation between the source content item and the one or more retrieved relevant content items may be generated based at least in part on the analysis. In this regard, for example, one or more relevant content items may be automatically and easily retrieved based solely on the selected source content item, or in other words, no additional information or criteria (e.g., metadata) other than the source image may be required to retrieve content items relevant to the source content item. A method, apparatus and computer program product may also be provided that create a mechanism for enabling the analysis and visualization of a link relation between all content items stored on a memory device.

In one exemplary embodiment, a method of providing analysis and visualization of content items associations is provided. The method may include performing, at a link analyzer, an analysis of a link relation between a source content item and at least one of a plurality of content items. The method may also include identifying at least one content item relevant to the source content item, wherein identifying at least one content item relevant to the source content item comprises identifying a similarity between at least one attribute associated with the source content item and at least one attribute associated with the at least one relevant content item. The method may further include determining a weight of the link relation based at least in part on the identified similarity. The method may additionally include providing for display of a link relation between the source content item and the identified at least one relevant content item.

In another exemplary embodiment, a computer program product for providing analysis and visualization of content items associations is provided. The computer program product includes at least one computer-readable storage medium having computer-executable program code instructions stored therein. The computer-executable program code instructions may include program code instructions for performing, at a link analyzer, an analysis of a link relation between a source content item and at least one of a plurality of content items, program code instructions for identifying at least one content item relevant to the source content item, wherein program code instructions for identifying at least one content item relevant to the source content item may comprise instructions for identifying a similarity between at least one attribute associated with the source content item and at least one attribute associated with the at least one relevant content item, program code instructions for determining a weight of the link relation based at least in part on the identified similarity, and program code instructions for providing for display of a link relation between the source content item and the identified at least one relevant content item.

In another exemplary embodiment, an apparatus for providing analysis and visualization of content items associations is provided. The apparatus includes a processor that may be configured to perform an analysis of a link relation between a source content item and at least one of a plurality of content items. The processor may further be configured to identify at least one content item relevant to the source content item, wherein the processor may be configured to identify at least one content item relevant to the source content item by identifying a similarity between at least one attribute associated with the source content item and at least one attribute associated with the at least one relevant content item. The processor may also be configured to determine a weight of the link relation based at least in part on the identified similarity, and provide for display of a link relation between the source content item and the identified at least one relevant content item.

In another exemplary embodiment, an apparatus for providing analysis and visualization of content items associations is provided. The apparatus may include means for performing an analysis of a link relation between a source content item and at least one of a plurality of content items, means for identifying at least one content item relevant to the source content item, wherein means for identifying at least one content item relevant to the source content item may comprise means for identifying a similarity between at least one attribute associated with the source content item and at least one attribute associated with the at least one relevant content item, means for determining a weight of the link relation based at least in part on the identified similarity, and means for providing for display of a link relation between the source content item and the identified at least one relevant content item.

Embodiments of the invention may provide a method, apparatus and computer program product for employment in a web based, other network or non-network based operating environment in mobile or fixed devices environments. As a result, for example, device users may enjoy improved capabilities with respect to applications and services accessible via the device, such as for example, the analysis and visualization of link relations between content items based at least in part on the similarities between the attributes associated with the content items. Accordingly, a user can easily cause one or more content items relevant to any selected content item to be automatically searched and retrieved without providing any additional information.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates a block diagram of a user terminal according to an exemplary embodiment of the present invention;

FIG. 2 is a schematic block diagram of a system showing an example of a communication environment according to an exemplary embodiment of the present invention;

FIG. 3 illustrates a schematic block diagram of an apparatus for providing analysis and visualization of content items associations according to an exemplary embodiment of the present invention;

FIG. 4 illustrates a diagram of exemplary attributes that may be associated with a content according to an exemplary embodiment of the present invention;

FIG. 5 illustrates exemplary link relations between content items according to an exemplary embodiment of the present invention;

FIG. 6 illustrates an exemplary weight calculation for link relations according to an exemplary embodiment of the present invention;

FIG. 7 illustrates an exemplary ranking of relevant content items according to an exemplary embodiment of the present invention;

FIGS. 8-11 are exemplary embodiments of a visualization of a link relation analysis according to an exemplary embodiment of the present invention;

FIG. 12A-B are exemplary screen shots of a user interface according to an exemplary embodiment of the present invention; and

FIG. 13 is a block diagram according to an exemplary method for providing analysis and visualization of content items associations according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. The terms “automatic,” “automatically,” “automated” or the like may be used interchangeably to refer to an action or operation requiring no user intervention. Thus, use of any such terms should not be taken to limit the spirit and scope of embodiments of the present invention.

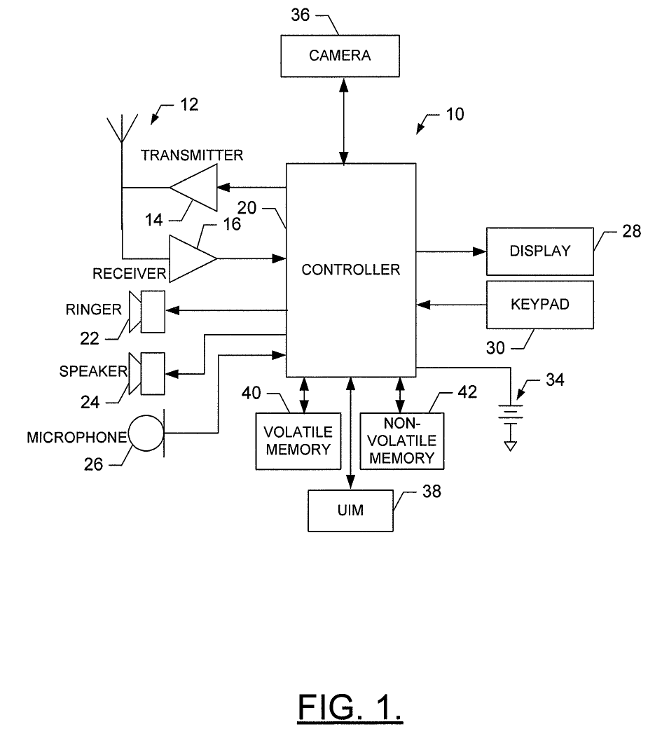

FIG. 1 illustrates a block diagram of a user terminal 10 (e.g., a mobile terminal) that may benefit from embodiments of the present invention. It should be understood, however, that a user terminal as illustrated and hereinafter described is merely illustrative of one type of device that may benefit from embodiments of the present invention and, therefore, should not be taken to limit the scope of embodiments of the present invention. While one embodiment of the user terminal 10 is illustrated and will be hereinafter described for purposes of example, other types of user terminals, such as portable digital assistants (PDAs), pagers, mobile computers, mobile televisions, gaming devices, laptop computers, cameras, video recorders, global positioning system (GPS) devices, mobile telephones, any combination of the aforementioned, and/or other types of voice and text communications systems, can readily employ embodiments of the present invention. Furthermore, devices that are not mobile may also readily employ embodiments of the present invention.

In addition, while several embodiments of the method of the present invention are performed or used by a user terminal 10, the method may be employed by other than a user terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The user terminal 10 may include an antenna 12 (or multiple antennas) in operable communication with a transmitter 14 and a receiver 16. The user terminal 10 may further include an apparatus, such as a controller 20 or other processing element, that may provide signals to and receive signals from the transmitter 14 and receiver 16, respectively. The signals may include signaling information in accordance with the air interface standard of the applicable cellular system, and/or may also include data corresponding to speech, received data and/or user generated/transmitted data. In this regard, the user terminal 10 may be capable of operating with one or more air interface standards, communication protocols, modulation types, and access types, such as, for example, any of a number of first, second, third and/or fourth-generation communication protocols or the like. As an alternative (or additionally), the user terminal 10 may be capable of operating in accordance with non-cellular communication mechanisms. For example, the user terminal 10 may be capable of communication in a wireless local area network (WLAN) or other communication networks.

The controller 20 may include circuitry implementing, among others, audio and logic functions of the user terminal 10. For example, the controller 20 may comprise a digital signal processor device, a microprocessor device, and various analog to digital converters, digital to analog converters, and/or other support circuits. Control and signal processing functions of the user terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional web browser. The connectivity program may then allow the user terminal 10 to transmit and receive web content, such as location-based content and/or other web page content, according to a Wireless Application Protocol (WAP), Hypertext Transfer Protocol (HTTP) and/or the like, for example.

The user terminal 10 may also comprise a user interface including an output device such as an earphone or speaker 24, a microphone 26, a display 28, and a user input interface, which may be operationally coupled to the controller 20. The user input interface, which allows the user terminal 10 to receive data, may include any of a number of devices allowing the user terminal 10 to receive data, such as a keypad 30, a touch display (not shown), a scrolling device, or other input device. In embodiments including the keypad 30, the keypad 30 may include numeric (0-9) and related keys (#, *), and other hard and soft keys used for operating the user terminal 10. Alternatively, the keypad 30 may include a QWERTY keypad arrangement. The keypad 30 may also include various soft keys with associated functions. In addition, or alternatively, the user terminal 10 may include an interface device such as a joystick or other user input interface. The user terminal 10 may further include a battery 34, such as a vibrating battery pack, for powering various circuits that are used to operate the user terminal 10, as well as optionally providing mechanical vibration as a detectable output.

In an exemplary embodiment, the user terminal 10 may include a camera module 36 in communication with the controller 20. The camera module 36 may be any means for capturing an image for storage, display or transmission. For example, the camera module 36 may include a digital camera capable of forming a digital image file from a captured image. As such, the camera module 36 may include all hardware, such as a lens or other optical device, and software necessary for creating a digital image file from a captured image, and to view an image.

The user terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the user terminal 10 may be equipped with memory. For example, the user terminal 10 may include volatile memory 40, such as volatile Random Access Memory (RAM) including a cache area for the temporary storage of data. The user terminal 10 may also include other non-volatile memory 42, which may be embedded and/or may be removable. The non-volatile memory 42 can additionally or alternatively comprise an electrically erasable programmable read only memory (EEPROM), flash memory, other non-volatile RAM (NVRAM) or the like. Non-volatile memory 40 may also include a cache area for the temporary storage of data. The memories can store any of a number of pieces of information, and data (e.g., content items), used by the user terminal 10 to implement the functions of the user terminal 10. For example, the memories may include an identifier, such as an international mobile equipment identification (IMEI) code, capable of uniquely identifying the user terminal 10. Furthermore, the memories may store instructions for determining cell id information. Specifically, the memories may store an application program for execution by the controller 20, which determines an identity of the current cell, e.g., cell id identity or cell id information, with which the user terminal 10 is in communication.

As used herein, the term “content item” may be used to refer to a media item (e.g., digital image file, song file, and/or the like), a multimedia item (e.g., video file), an application, and/or the like. In some embodiments, attributes (e.g., metadata) may be associated with the content item such as, for example, time, location, event, and/or the like. Further, the term “user digital image space (UDIS)” may be used to refer to a memory device (e.g., a database) that may be used to store one or more content items and attributes associated with the content items. In some examples, the UDIS may be local (e.g., on a user terminal) or remotely located (e.g., on a network entity). In some embodiments the content items and associated attributes may be stored on respective databases within the UDIS. In other embodiments, the content items and associated attributes may be stored on the same database. In some situations, the UDIS may store one type of content item (e.g., a media item such as an image), while in other situations, the UDIS may store various types of content items (e.g., one or more types of media, multimedia, application, and/or the like).

The term “link relation” may be used to refer to a connection or association between at least two content items based at least in part on the similarities of one or more of their respective attributes (e.g., one or more same or similar attributes). In some situations, the attributes may be metadata. For example, a link relation may exist between two images if the images have one or more similar metadata such as capture time. The term “visualization” may be used to refer to a graphical representation, other representation, and/or the like. Thus, for example, a visualization of the link relation between at least two content items may be used to refer to a graphical representation of the link relation of the content items, such as, for example, a graph. Thus, use of any such terms should not be taken to limit the spirit and scope of embodiments of the present invention.

Exemplary embodiments of the present invention generally provide a method, apparatus and computer program product for providing analysis and visualization of content items associations. In particular, a method, apparatus and computer program product are provided that create a mechanism for enabling the analysis and visualization of a link relation between at least two content items (e.g., media such as images, multimedia, and/or the like). The content items may be stored on a memory device (e.g., a database) that may store a plurality of other content items. The database may also store attributes (e.g., metadata) associated with the content items such as, for example, time, location, storage information, and/or the like. Thus, for example, the content items may be arranged and managed based at least in part on their attributes. As such, a link relation may exist between at least two content items based at least in part on the similarities of their respective attributes (e.g., one or more same or similar respective attributes).

A method, apparatus and computer program product may thus be provided that create a mechanism for enabling the analysis and visualization of a link relation between content items in a database based at least in part on the similarities of their respective attributes. Accordingly, a user may easily search and retrieve one or more content items relevant to a selected source content item based at least in part on the analysis and/or visualization of the link relations between the source content item and the relevant content items without specifying any additional information (e.g., metadata). For example, a user may select a first image (e.g., source image) from a UDIS and desire to search for one or more images from the UDIS relevant to the source image. An analysis may be performed to identify the link relation between the source image and the one or more images stored on the UDIS based on the metadata associated with the source image. For instance, a comparison may be performed between the metadata associated with the source image and the metadata associated with the images on the UDIS to identify any similarities between the respective metadata (e.g., one or more same or similar metadata, generally referred to as similar metadata). In this regard, if there are one or more similar metadata between the source image and one or more content items (or in other words, one or more similar metadata between the source image and each of one or more content items) then there may be a link relation the source image and each of the one or more content items. These one or more content items may thus be considered relevant images.

A weight may be determined for each link relation between the source image and each of the relevant content items based at least on the total number of similar metadata (e.g., a weight may be determined between two images). For example, the weight may be determined or computed by adding the total number of similar metadata for each link relation (e.g., between the source image and each of one or more images). In some situations, the weight may be used to provide a rank for the relevant images, or otherwise, order or arrange the relevant images in order based at least in part on relevancy (e.g., weight or total number of similar metadata) to the source image. For example, the relevant images may be ordered from most relevant (e.g., highest total number of similar metadata) to least relevant (e.g., lowest total number of similar metadata), or vice versa. Exemplary embodiments of the present invention may enable the relevant images to be retrieved and provided to the user (e.g., in the form of a generated graph or other graphical representation which may be based at least in part on the weight of each link relation) based solely on the selected source image, or in other words, no additional information or criteria (e.g., metadata) other than the source image may required to retrieve the relevant images. In this regard, exemplary embodiments of the present invention may take into consideration one or more different types of metadata (e.g., embedded metadata) associated with at least two images, and build a link relation (and a corresponding weight of the link relation) between at least two images stored in a UDIS. A method, apparatus and computer program product may also be provided that create a mechanism for enabling the analysis and visualization of a link relation between all images in a UDIS based at least in part on the similarities of their respective metadata.

Although exemplary embodiments of the present invention may be described generally with respect to images, embodiments of the present invention may be equally applicable to other types of media items (e.g., music files), multimedia items, applications, other types of content items, and/or the like. Also, although exemplary embodiments of the present invention may be described generally with respect to retrieving one or more content items of the same type as that of a source content item, embodiments of the present invention may be equally applicable to retrieving one or more content items of a type different than that of a source content item but related to the source content item. Moreover, although exemplary embodiments of the present invention may be described generally with respect to content items and associated attributes stored in one memory device (e.g., a UDIS), embodiments of the present invention may be equally applicable to content items and associated attributes stored on multiple memory devices (e.g., multiple UDISs). For example, exemplary embodiment of the present invention may enable an analysis and visualization of a link relation between at least two content items (or all content items) in a plurality of UDISs based at least in part on the similarities of their respective attributes.

Similarly, although exemplary embodiments of the present invention may be described generally with respect to the source content item and the relevant content items being stored on the same UDIS, embodiments of the present invention may be equally applicable to the source content item and the relevant content items being stored on different memory devices. For example, the source content item may be stored on memory device at the network entity and the related content items may be stored locally on the user terminal, or vice versa. Additionally, although exemplary embodiments of the present invention may be described generally with respect to one method of weight calculation (e.g., totaling the number of similar attributes), other embodiments may be equally applicable to various other methods of weight calculation, algorithms, and/or the like, which may be more complex and/or include other mathematical operations in addition to or in the alternative of additional operations.

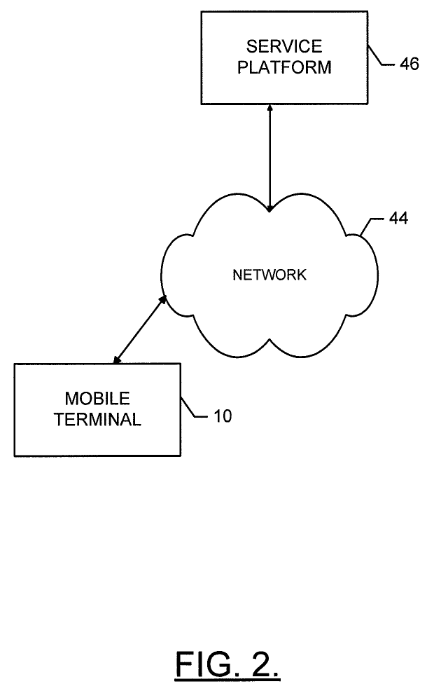

FIG. 2 illustrates a generic system diagram in which a device such as a user terminal 10, which may benefit from embodiments of the present invention, is shown in an exemplary communication environment. As shown in FIG. 2, an embodiment of a system in accordance with an example embodiment of the present invention may include a communication device (e.g., user terminal 10) and a network entity (e.g., a service platform 46) capable of communication with each other via a network 44 to provide, request and/or receive information. In some embodiments, either or both of the user terminal 10 and the service platform 46 may include an apparatus 50 that may be configured to employ embodiments of the present invention. In this regard, it should be noted that the apparatus 50, which will be described in greater detail below, may be separately embodied at either one of the user terminal 10 or service platform 46 or at both of the user terminal 10 and the service platform 46 entirely or in a distributed manner. In some cases, embodiments of the present invention may further include one or more additional communication devices. In some embodiments, not all systems that employ embodiments of the present invention may comprise all the devices illustrated and/or described herein.

The network 44 may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network 44. Although not necessary, in some embodiments, the network 44 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. In some embodiments, the network 44 may be a peer-to-peer (P2P) network.

In an example embodiment, the service platform 46 may be a device or node such as a server or other processing element. The service platform 46 may have any number of functions or associations with various services. As such, for example, the service platform 46 may be a platform such as a dedicated server (or server bank) associated with a particular information source or service (e.g., a search service and/or a mapping service), or the service platform 46 may be a backend server associated with one or more other functions or services. As such, the service platform 46 may represent a plurality of different services or information sources. The functionality of the service platform 46 may be provided by hardware and/or software components configured to operate in accordance with known techniques for the provision of information to users of communication devices. However, some of the functionality provided by the service platform 46 may be information provided in accordance with embodiments of the present invention. The user terminal 10 may run a client application configured to communicate with a corresponding server function at the service platform 46.

In an exemplary embodiment, the service platform 46 may be configured to perform analysis and visualization of content items associations. The service platform 46 may include a memory device (e.g., a UDIS) or otherwise be configured to access a remote memory device which may be used to store one or more content items thereon. For example, the service platform 46 may receive one or more content items (e.g., from a user terminal 10) to be stored on the UDIS or other memory device(s) associated with the service platform 46. In this regard, the user terminal 10 may be configured to transfer or otherwise upload one or more content items to the service platform 46 to be stored on a memory device associated with the service platform 46. The service platform 46 may be configured to receive the selection of one or more source content items (e.g., from a user terminal 10), and perform an analysis and visualization of content items associations, which may be based on the selected source content items. As mentioned above, the user terminal 10 may include an apparatus 50 that may be configured to employ embodiments of the present invention, and as such, the user terminal 10 may also be configured to select of one or more source content items (e.g., from a user terminal 10) and perform an analysis and visualization of content items associations.

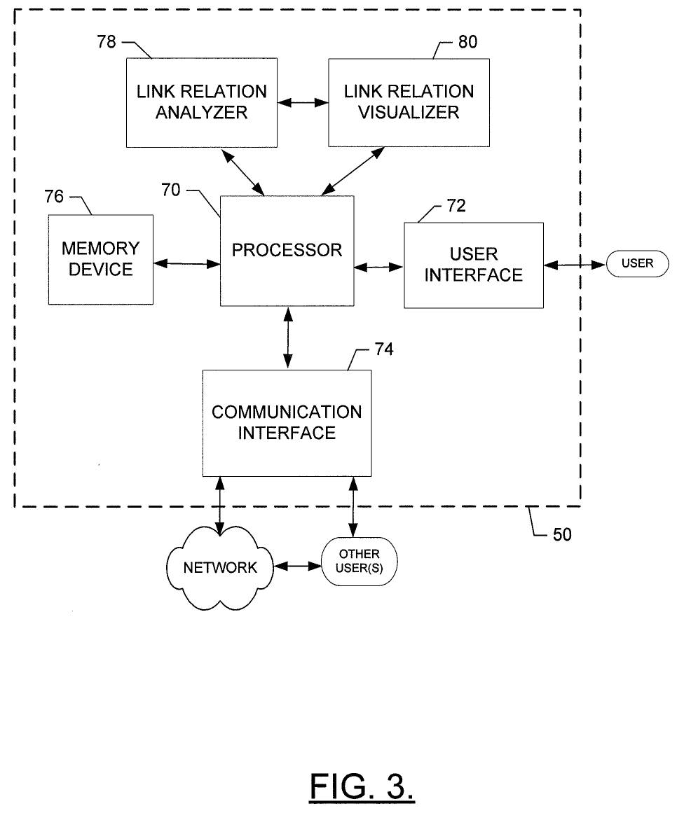

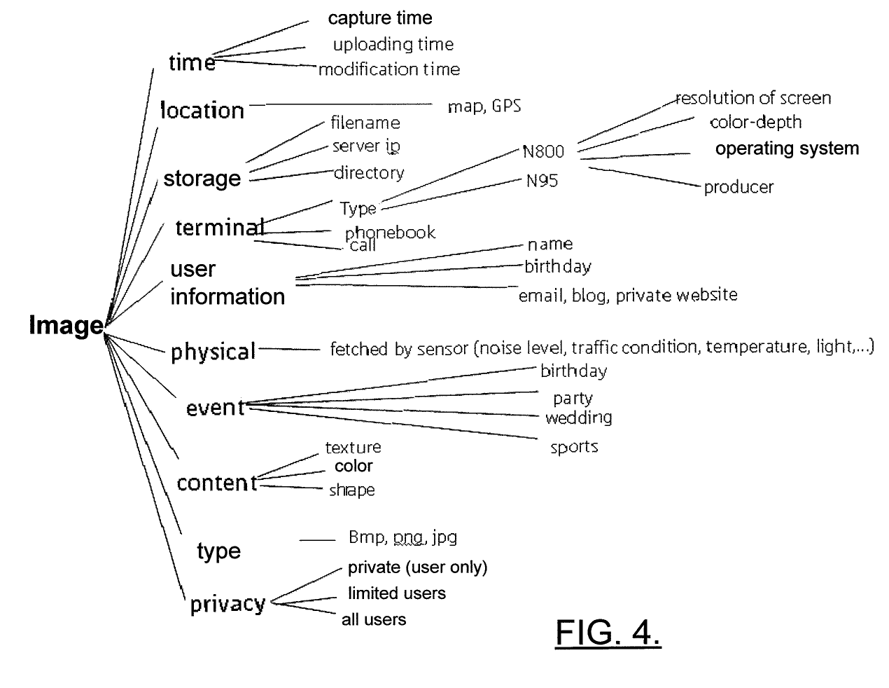

FIG. 3 illustrates a schematic block diagram of an apparatus for enabling the provision of analysis and visualization of content items associations according to an exemplary embodiment of the present invention. An exemplary embodiment of the invention will now be described with reference to FIG. 3, in which certain elements of an apparatus 50 for providing analysis and visualization of content items associations are displayed. The apparatus 50 of FIG. 3 may be employed, for example, on the user terminal 10 (and/or one or more other communication device). Alternatively, the apparatus 50 may be embodied on a network entity or device of the network 44. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the user terminal 10, the service platform 46), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 3, an apparatus 50 for providing analysis and visualization of content items associations is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

In exemplary embodiments, the memory device 76 may be embodied as or include a UDIS (e.g., a database) which may be used to store one or more content items and attributes associated with the content items. The UDIS may be a large database to accommodate the storage of a plurality of content items and associated attributes. In some embodiments the content items and associated attributes may be stored on respective databases within the UDIS. For example, the content items may be stored on one database and the associated attributes may be stored on a different database. In other embodiments, the content items and associated attributes may be stored on the same database. In some situations, the UDIS may store one type of content item (e.g., one type of media item such as an image, media items regardless of their types, multimedia items regardless of their types, etc.), while in other situations, the UDIS may store various types of content items (e.g., one or more types of media, multimedia, application, and/or the like). The UDIS may be located locally with respect to the apparatus 50, or located remotely from the apparatus 50 and thus remotely accessible to the apparatus 50.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity capable of performing operations according to embodiments of the present invention while configured accordingly.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 44). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse or other scrolling device, a joystick, a display, a touch screen, a microphone, a speaker, or other input/output mechanisms. In an exemplary embodiment in which the apparatus is embodied as a server or some other network devices, the user interface 72 may be limited, remotely located, or eliminated.

In an exemplary embodiment, the processor 70 may be embodied as, include or otherwise control a link relation analyzer 78 and a link relation visualizer 80. The link relation analyzer 78 and the link relation visualizer 80 may each be any means such as a device or circuitry embodied in hardware, a computer program product or a combination of hardware and software (e.g., processor 70 operating under software control, the processor 70 embodied as an ASIC or FPGA specifically configured to perform the operations described herein, or a combination thereof) that is configured to perform the corresponding functions of the link relation analyzer 78 and the link relation visualizer 80, respectively, as described below.

In an exemplary embodiment, any or all of the link relation analyzer 78 and the link relation visualizer 80 may include instructions, code, modules, applications and/or circuitry for providing respective portions of analysis and visualization of content items associations. However, it should be noted that code, circuitry and/or instructions associated with the link relation analyzer 78 and the link relation visualizer 80 need not necessarily be modular. In some embodiments, communication between the link relation analyzer 78 and the link relation visualizer 80 is conducted via the processor 70. However, the link relation analyzer 78 and the link relation visualizer 80 are alternatively in direct communication with each other or may have no communication with each other in other embodiments.

The link relation analyzer 78 may be configured to perform analysis of a link relation between at least two content items based at least in part on the similarities of the one or more attributes respectively associated with the content items (e.g., in response to receiving a request to perform the analysis of at least two content items). In the event the UDIS contains a large number of content items and/or attributes, predetermined criteria may be provided with the analysis (based in least in part on user input or user preference(s)) such as, for example, a time limit for performing the analysis, a predetermined number of content items to analyze, and/or the like. In some situations, the link relation analyzer 78 may be configured to perform the analysis of the link relations between all the content items of a memory device (e.g., UDIS), for example, in response to a user input, or automatically based at least in part on one or more predetermined conditions or criteria. In other situations, the link relation analyzer 78 may be configured to perform the analysis of the link relations between a source content item (e.g., a source image) and one or more content items (e.g., one or more images) of a UDIS based at least in part on the metadata associated with the source content item. In this regard, the link relation may be configured to receive the selection of a source content item (e.g., from a user). The link relation analyzer 78 may be thus configured to identify one or more metadata associated with the source content item and one or more content items.

In this regard, and referring now to FIG. 4, a diagram of exemplary attributes that may be associated with a content item according to an exemplary embodiment of the present invention is illustrated. As shown, one or more attributes (e.g., metadata) may be associated with a content item (e.g., an image). The attributes may comprise various levels such as, for example, first level of categories, second level of categories, third level of categories, and/or the like. For example, a first level of categories may include, for example, time, location, storage, terminal, user information, physical, event, content, type, privacy, and/or the like. As a further example, the category of time (second level) may include the second level of categories of capture time, uploading time, modification time, and/or the like. The category of type (second level under the category of terminal) may include N95 and N800, which include the further categories of screen resolution, operating system, and/or the like.

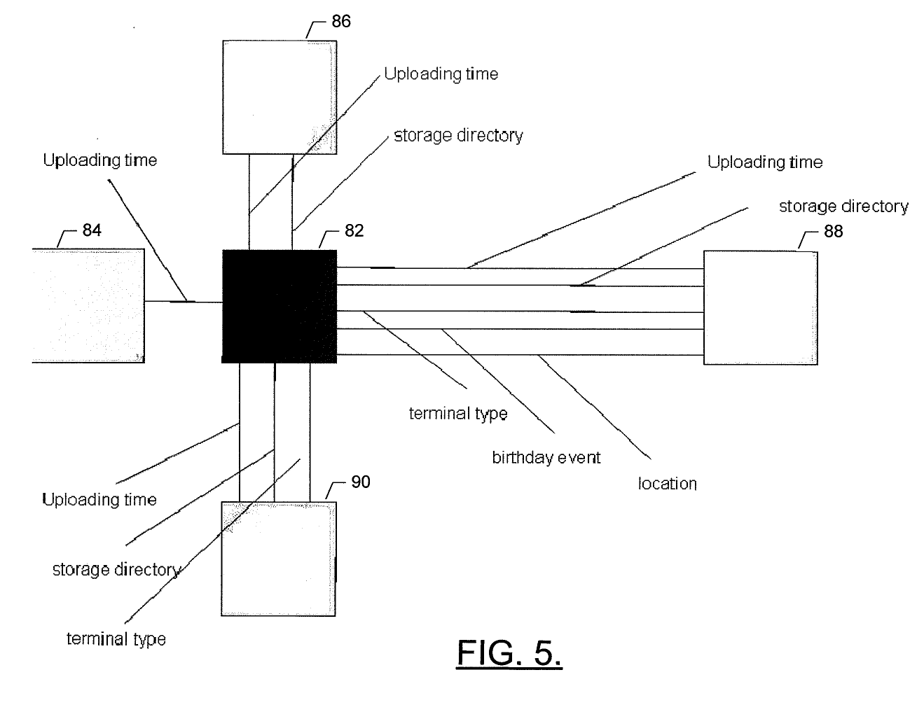

Referring back to FIG. 3, the link relation analyzer 78 may be configured to compare one or more metadata associated with the source content item with one or more metadata associated with each of one or more content items of the UDIS to identify any similarities between the respective attributes (e.g., compare one or more attributes of a source content item with one or more attributes of a content item). For example, the link relation analyzer 78 may compare one or more attributes of a source content item with one or more attributes of first, second, and/or third content items, and so forth. In some cases, for example, the link relation analyzer 78 may be configured to access the UDIS to retrieve a source content item and one or more content items (e.g., from a database storing content items), and one or more attributes associated (e.g., from a database storing attributes) with the retrieved source item and one or more content items, respectively. The attributes may be compared (e.g., based on the first level, second level, and/or third level of attribute categories, and/or the like) to identify and/or retrieve one or more relevant content items based on any similarities between one or more attributes of the source content item and one or more respective attributes of one or more identified relevant content items. In this regard, and referring now to FIG. 5, link relations between content items according to an exemplary embodiment of the present invention are illustrated. As shown, a content item may be associated with or otherwise connected to one or more other content items based at least in part on the similarities of the respective one or more attributes. For example, a plurality of content items 84-90 may be connected or otherwise identified as relevant to a source content item 82 based at least in part on the similarities between their respective one or more attributes and the attributes of the source content item. As illustrated, the source content item 82 and content item 84 may have one similar attribute, the source content item 82 and content item 86 may have 2 similar attributes, and so forth. For example, the uploading time of the source content item 82 and content item 84may be similar (e.g., the same or similar uploading time). In a further example, the storage directory of source content item 82 and content item 86 may be similar (e.g., the same or similar directory), in addition to the uploading time. In yet a further example, the terminal type of source content item 82 and content item 90 may be similar (e.g., the same or similar terminal such as, for example, a mobile terminal), in addition to the storage directory and the uploading time. In some examples, at least one similar attribute may be sufficient to establish a link relation between two images, while in other examples, more than one similar attribute may be necessary to establish a link relation. As such, in some examples, the content item 84 may not be considered relevant.

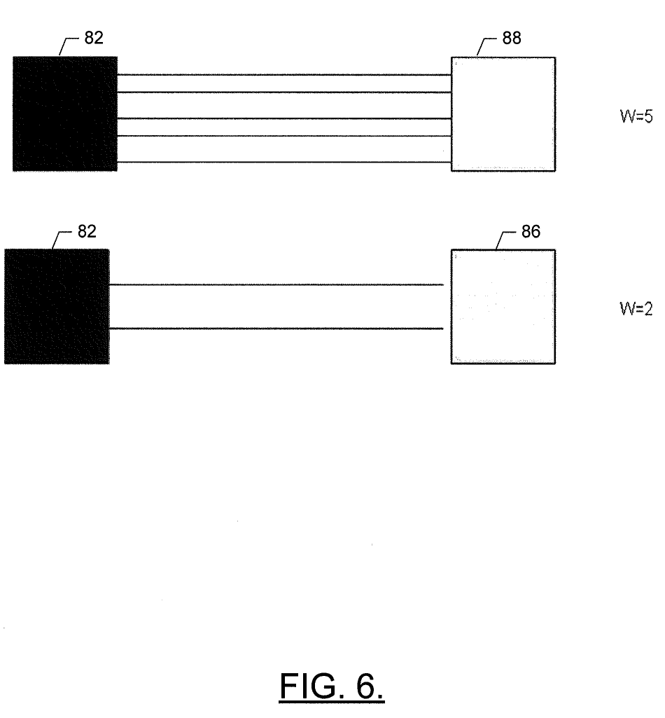

Referring back to FIG. 3, the link relation analyzer 78 may be configured to determine a weight of the link relation between the source content item and the one or more identified relevant content items based at least in part on the identified similarities between one or attributes of the source content item and one or more attributes for each of the relevant content items. In this regard, the link relation analyzer 78 may be configured to determine the weight of the link relation by adding the total number of similar attributes between each relevant content item 84-90 and the source content item 82. For example, and as illustrated in FIG. 6, the weight of the link relation between the source content item 82 and the content item 88 may be five based on the five similar attributes between the source content item 82 and the content item 88 (e.g., uploading time, storage directory, terminal type, birthday event, and location). As further example, and still referring to FIG. 6, the weight of the link relation between the source content item 82 and the content item 86 may be two based on the two similar attributes between the source content item 82 and the content item 86 (e.g., uploading time and storage directory). In this regard, in the present embodiment, each similar attribute may be given a same value (e.g., a value of one). However, in other embodiments, one similar attribute may be given a higher value than another similar attribute based on predetermined criteria. For example, privacy attribute(s) may be given a higher value than time attribute(s) because privacy attribute(s) may be more relevant. In another example, user information attribute(s) may be given a higher value than content attribute(s) because a user may care more about information pertaining to the user than information indicative of content (e.g., color, shape, etc.).

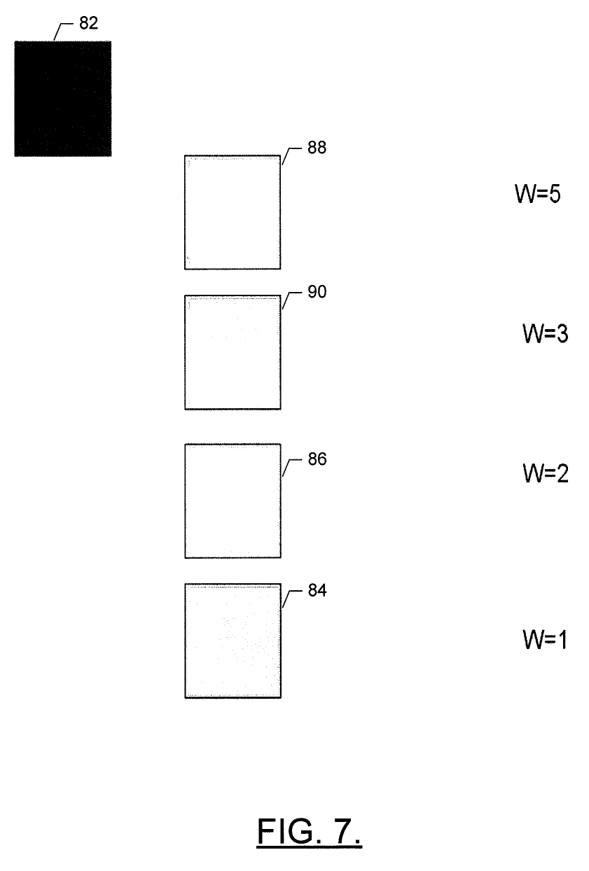

Referring back to FIG. 3, the link relation analyzer 78 and/or the link relation visualizer 80 may be configured to arrange or rank the retrieved relevant content items based at least in part on the weight of the respective link relation of the identified content items. For example, the identified content items may be ranked in various orders, such as for example, in order of relevancy. For instance, and as illustrated in FIG. 7, the identified content items may ranked in a descending order of weight (e.g., from most relevant to least relevant). In this regard, content 88 may be first while content item 84 may be last. In other examples, the identified content items may be ranked in an ascending order of weight. Referring back to FIG. 3, the link relation analyzer 78 may be configured to communicate information regarding the analysis of link relation(s) (e.g. the identified relevant content item(s), the corresponding weight of the link relation(s), the corresponding rank or arrangement, and/or the like) to the link relation visualizer 80.

As mentioned above, the link relation visualizer 80 may be configured to arrange or rank the retrieved relevant content items based at least in part on the weight of the respective link relation of the identified content items. The link relation visualizer 80 may also be configured to provide a visualization of the link relation(s) between at least two content items. In this regard, the link relation visualizer 80 may be configured to generate one or more graphical representations of the link relation(s) between at least two content items (e.g., in a memory device such as a UDIS) based at least in part on the information received from the link relation analyzer 78. As such, the link relation visualizer 80 may be configured to generate graphs (e.g., unidirectional graphs, circular graphs, directional graphs), other graphical representations, and/or the like. The link relation visualizer 80 may be configured to receive the selection of one or more content items on the graphical representation (e.g., from a user), identify one or more content items relevant to the selected content item(s) and their respective link relations. The link relation visualizer 80 may also be configured to provide an indication of the content item(s) on the graph (e.g., to the user) and their respective link relations, along with the weight and similar attributes of each link relation.

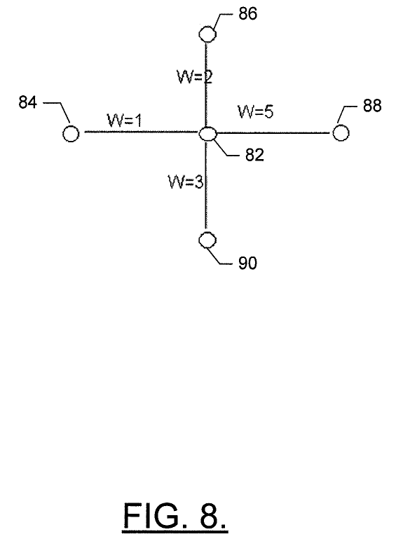

In this regard, and referring now to FIGS. 8-11, exemplary embodiments of a visualization of a link relation analysis according to an exemplary embodiment of the present invention are illustrated. Referring to FIG. 8, an exemplary embodiment of an undirected weight graph illustrating the link relation(s) between a source content item (e.g., content item 82) and various content items (e.g., relevant content items 84-90) is provided. The content items may be illustrated as vertexes and the link relation(s) may be illustrated as edges. The number of the similar attributes between content items may be illustrated as weight. The link relation between two content items may be symmetric. Based on the undirected weight graph, the link relation of the content items (e.g., in memory device such as a UDIS) may be visualized.

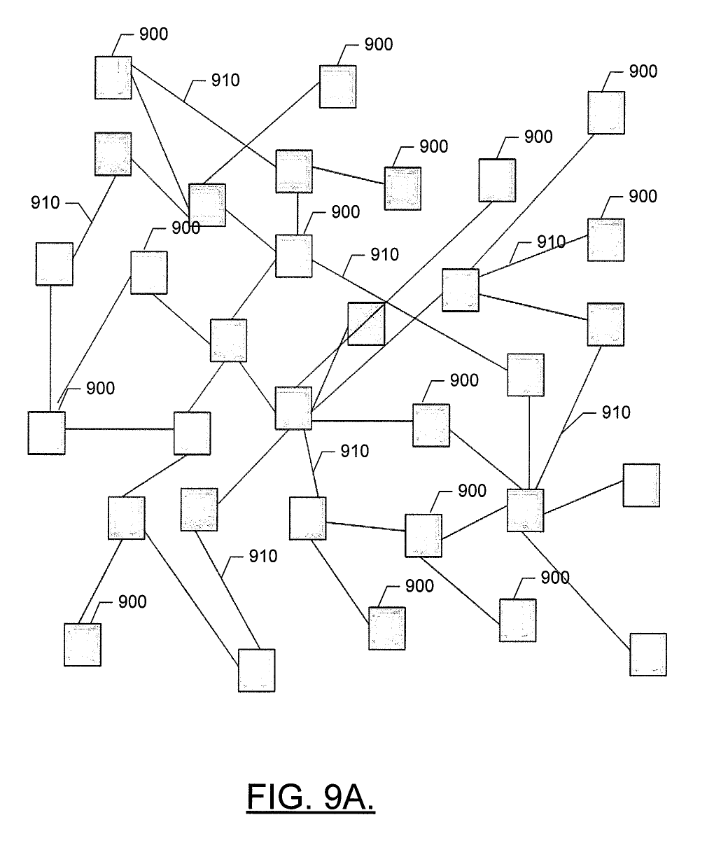

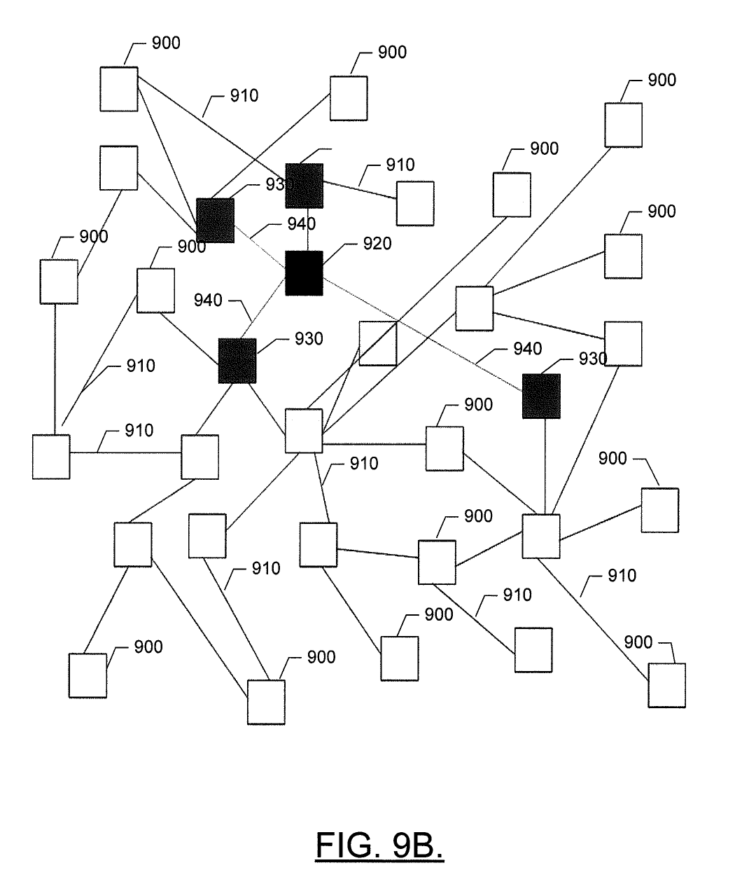

FIGS. 9A-B provide an exemplary embodiment of a visualization of a link relation analysis according to an exemplary embodiment of the present. More particularly, FIG. 9A illustrates an exemplary embodiment of an undirected graph for a plurality of content items (e.g., all the content items) in a memory device such as, for example, a UDIS. As shown, the graph may comprise a plurality of content items 900 and a plurality of link relations 910. In some examples, the content items of the same weight may have the same color, size, shape, and/or the like, and as such may be readily identified. As illustrated for example, each content item may have at least one attribute that is similar to the attribute of another content item. As such, each content item may be relevant to at least one other content item. FIG. 9B illustrates another exemplary embodiment of an undirected graph for a plurality of content items (e.g., all the content items) in a memory device such as, for example, a UDIS. In this regard, a content item 920 (e.g., a source content item) may be selected on the graph (e.g., from an input by a user). In response to the selection of the content item, one or more content items 930 relevant to content item 920 may be highlighted, along with their respective link relations 940 between the content items and the source content item. In some examples, a desired link relation (e.g., an edge) may be selected and the corresponding weight, similar attributes, and/or the like may be provided.

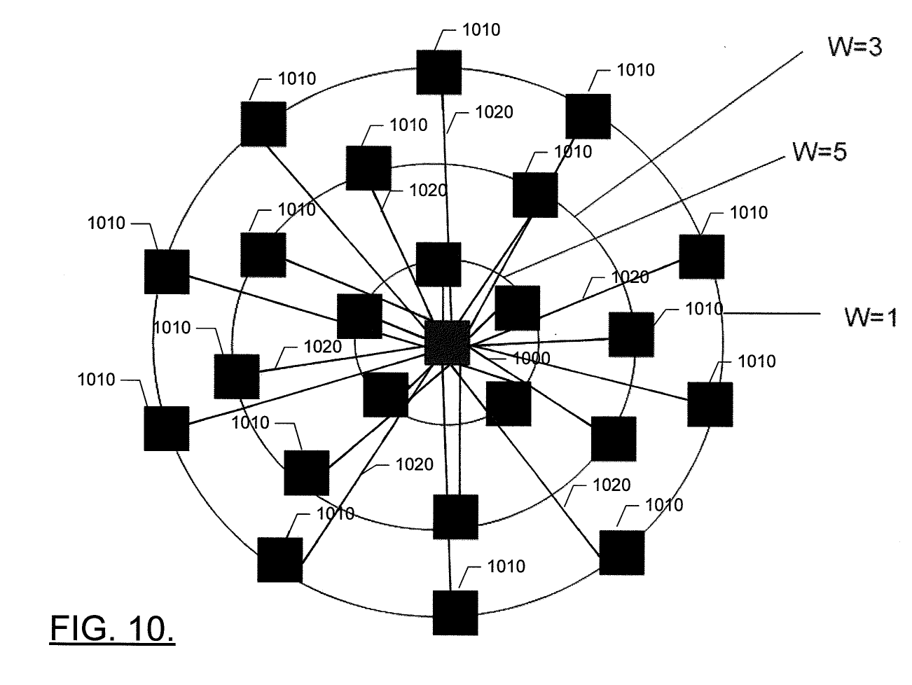

FIG. 10 provides an exemplary embodiment of a visualization of a link relation analysis according to an exemplary embodiment of the present invention. More particularly, FIG. 10 provides a visualization of the link relations illustrated as a circular graph. As shown, a source content item 1000, a plurality of content items 1010 relevant to content item 1000, and a plurality of link relations 1020 are provided. In this regard, the source content item 1000 may be provided in the center of the graph (e.g., the centre of a circle). In some situations, the relevant images with the largest link relation weight may be provided closest to the center of the graph (e.g., closest to the source content item), while the relevant content items with the smallest link relation weight may be provided furthest away from the center of the graph, or vice versa. For example, the relevant content items with the link relation weight of five may be provided nearest to the center, the relevant content items with the link relation weight of three may be provided second nearest to the center, and so forth. In other instances, although the distance of the relevant content items from the center may not be determined by weight, all the relevant content items with the same weight may be provided within the same distance from the center.

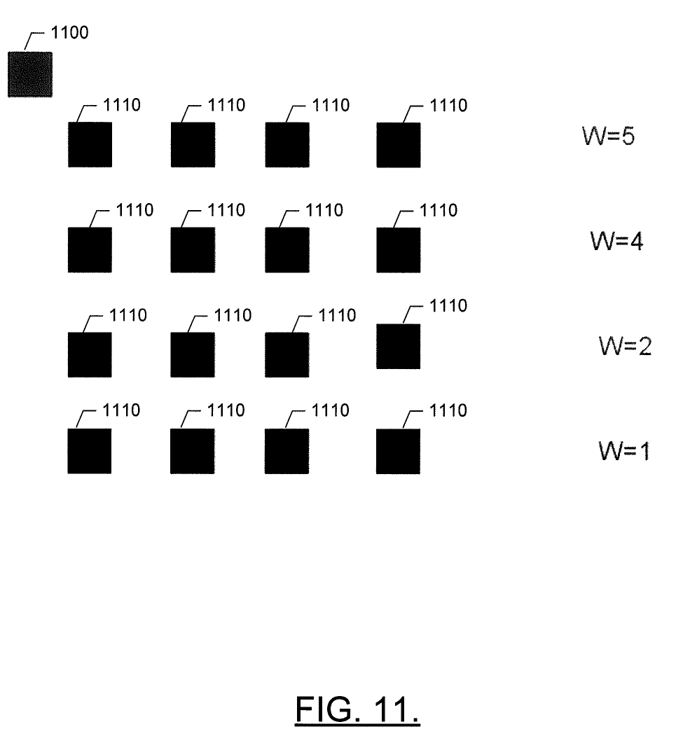

FIG. 11 provides an exemplary embodiment of a visualization of a link relation analysis according to an exemplary embodiment of the present invention. As shown, a source content 1100 is illustrated with a plurality of content items 1110 relevant to the source content 1100, which may be arranged in a matrix based at least in part on various different criteria or order (e.g., weight of the link relation). In some examples, the rows of the matrix may be arranged based at least in part on the weight of the relevant content items 1110. In some situations, the rows may be arranged in an order of descending weight (or vice versa). For example, the content items with a link relation weight of five may be provided on the first row, the content items with a link relation weight of four may be provided on the second row, the content items with a link relation weight of four may be provided on the third row, and so forth. In other situations, the columns may in an order of descending weight (or vice versa).

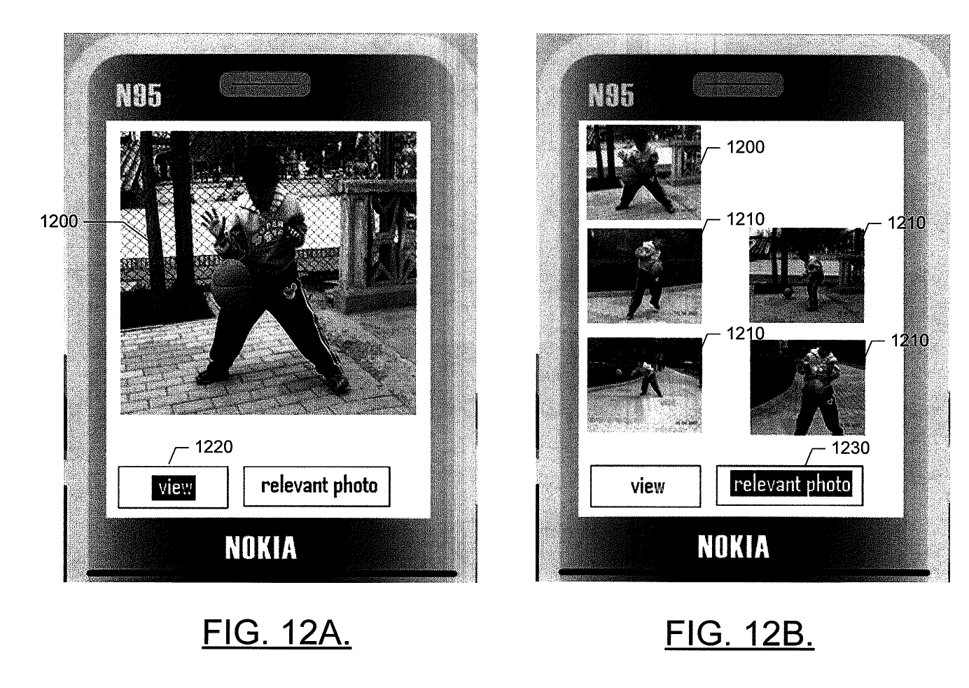

FIGS. 12A-B are exemplary screen shots of a user interface according to an exemplary embodiment of the present invention. FIG. 12A illustrates an exemplary user interface with a content item 1200 (e.g., source image) which may be displayed in response to a user depressing a view button 1220. The source image 1200 may an image locally stored at a user terminal or an image remotely stored at a network entity (e.g., online album application). Referring now to FIG. 12B, a user may depress a button 1230 to retrieve all the content items (e.g., images) relevant to the source image 1200. As such, all the images relevant to the source image 1200 may be retrieved and provided for display. As indicated above, the relevant images may be retrieved based solely on the source image. As such, the user need not input any information in addition to the selected source image. In some examples, the relevant images may be arranged in a matrix as discussed above. The source images and/or relevant images may also be arranged in an undirected graph, circular graph, or other graphical representations.

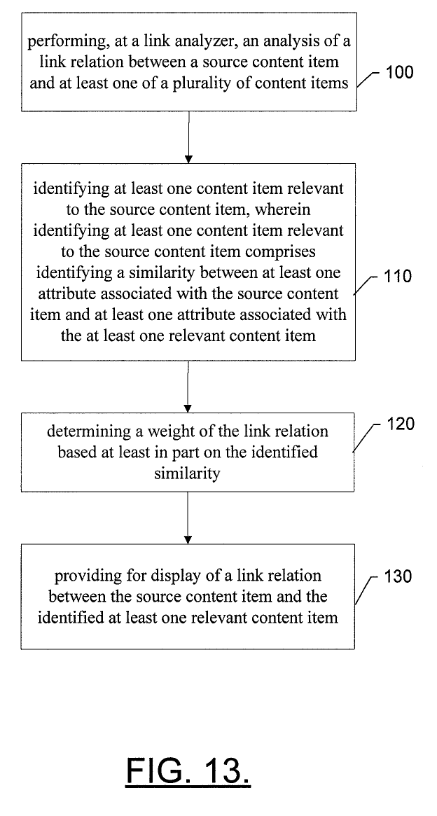

FIG. 13 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the user terminal or network device and executed by a processor in the user terminal or network device. As will be appreciated, any such computer program instructions may be loaded onto a computer or other programmable apparatus (i.e., hardware) to produce a machine, which, in turn, provides means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instructions which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instructions for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing analysis and visualization of content items associations as illustrated, for example, in FIG. 13 may include performing, at a link analyzer, an analysis of a link relation between a source content item and at least one of a plurality of content items at operation 100. The method may also include identifying at least one content item relevant to the source content item, wherein identifying at least one content item relevant to the source content item comprises identifying a similarity between at least one attribute associated with the source content item and at least one attribute associated with the at least one relevant content item at operation 1 10. The method may further include determining a weight of the link relation based at least in part on the identified similarity at operation 120. The method may additionally include providing for display of a link relation between the source content item and the identified at least one relevant content item at operation 130.

In some embodiments, certain ones of the operations above may be modified or further amplified as described below. It should be appreciated that each of the modifications or amplifications below may be included with the operations above either alone or in combination with any others among the features described herein. In this regard, for example, invoking, at an application manager, a substitute function expansion application to request access to content associated with an object at operation 100 may include invoking the substitute function expansion application to request access to content associated with an object provided within a defined area of a page retrieved by a browser application. In some cases, the method may further include further comprising performing, at the link analyzer, a comparison between the at least one attribute associated with the source content item and the at least one attribute associated with the at least one of a plurality of content items. In other cases, the method may further include receiving a request to retrieve at least one content item relevant to a source content item based at least in part on receiving a selection of the source content item. Alternatively or additionally, the method may also include providing for display of link relations for a plurality of content items wherein each one of the plurality of content items is linked to at least another one of the plurality of content items. In some cases, providing for display of a link relation at operation 130 may include providing the at least one relevant content item in a position relative to the position of the source content item.

In exemplary embodiments, providing for display of a link relation at operation 130 may include generating a graphical representation indicative of an association between the source content item and the at least one relevant content item. In other embodiments, determining a weight of the link relation at operation 120 may include determining a rank of the at least one content item. In yet other embodiments, determining a weight of the link relation at operation 120 may include determining a weight of the link relation based at least in part on a total number of similar attributes between the source content item and the at least one relevant content item. In some situations, generating a graphical representation may include generating at least one of a circular graph, undirected graph, or a matrix arrangement. In other situations, performing an analysis of a link relation at operation 100 may include performing an analysis of a link relation in response to receiving a selection of the source content item. In other examples, the method may include selecting a content item (e.g., an image) from a UDIS (e.g., picture folder on a user terminal, an online album, and/or the like) to be viewed. The method may further include receiving a request to search and retrieve content items relevant to the selected content item.

In an exemplary embodiment, an apparatus for performing the method of FIG. 13 above may comprise a processor (e.g., the processor 70) configured to perform some or each of the operations (100-130) described above. The processor may, for example, be configured to perform the operations (100-130) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-130 may comprise, for example, the processor 70 such as a processor executing an algorithm for processing information as described above, the link relation analyzer 78 and/or the link relation visualizer 80.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
performing, at a link analyzer, an analysis of a link relation between a source content item and at least one of a plurality of content items;
identifying at least one content item relevant to the source content item, wherein identifying at least one content item relevant to the source content item comprises identifying a similarity between at least one attribute associated with the source content item and at least one attribute associated with the at least one relevant content item;
determining a weight of the link relation based at least in part on the identified similarity; and
providing for display of a link relation between the source content item and the identified at least one relevant content item.

2. The method of claim 1, further comprising performing a comparison between the at least one attribute associated with the source content item and the at least one attribute associated with the at least one of a plurality of content items.

3. The method of claim 1, wherein providing for display of a link relation comprises generating a graphical representation indicative of an association between the source content item and the at least one relevant content item.

4. The method of claim 3, wherein generating a graphical representation comprises generating at least one of a circular graph, undirected graph, or a matrix arrangement.

5. The method of claim 1, wherein determining a weight of the link relation comprises determining a weight of the link relation based at least in part on a total number of similar attributes between the source content item and the at least one relevant content item.

6. The method of claim 1, wherein performing an analysis of a link relation comprises performing an analysis of a link relation in response to receiving a selection of the source content item.

7. The method of claim 1, further comprising providing for display of link relations for a plurality of content items wherein each one of the plurality of content items is linked to at least another one of the plurality of content items.

8. A computer program product comprising at least one computer-readable storage medium having computer-executable program code instructions stored therein, the computer-executable program code instructions comprising:
program code instructions for performing an analysis of a link relation between a source content item and at least one of a plurality of content items;
program code instructions for identifying at least one content item relevant to the source content item, wherein program code instructions identifying at least one content item relevant to the source content item comprises instructions identifying a similarity between at least one attribute associated with the source content item and at least one attribute associated with the at least one relevant content item;
program code instructions for determining a weight of the link relation based at least in part on the identified similarity; and
program code instructions for providing for display of a link relation between the source content item and the identified at least one relevant content item.

9. A computer program product according to claim 8, further comprising program code instructions for performing a comparison between the at least one attribute associated with the source content item and the at least one attribute associated with the at least one of a plurality of content items.

10. A computer program product according to claim 8, wherein program code instructions for providing for display of a link relation comprises instructions for generating a graphical representation indicative of an association between the source content item and the at least one relevant content item.

11. A computer program product according to claim 10, wherein program code instructions for generating a graphical representation comprises instructions for generating at least one of a circular graph, undirected graph, or a matrix arrangement.

12. A computer program product according to claim 8, wherein program code instructions for determining a weight of the link relation comprises instructions for determining a weight of the link relation based at least in part on a total number of similar attributes between the source content item and the at least one relevant content item.

13. A computer program product according to claim 8, wherein program code instructions for performing an analysis of a link relation comprises instructions for performing an analysis of a link relation in response to receiving a selection of the source content item.

14. A computer program product according to claim 8, further comprising program code instructions for providing for display of link relations for a plurality of content items wherein each one of the plurality of content items is linked to at least another one of the plurality of content items.

15. An apparatus comprising a processor configured to:
perform an analysis of a link relation between a source content item and at least one of a plurality of content items;
identify at least one content item relevant to the source content item, wherein the processor is configured to identify at least one content item relevant to the source content item by identifying a similarity between at least one attribute associated with the source content item and at least one attribute associated with the at least one relevant content item;
determine a weight of the link relation based at least in part on the identified similarity; and
provide for display of a link relation between the source content item and the identified at least one relevant content item.

16. An apparatus according to claim 15, wherein the processor is further configured to perform a comparison between the at least one attribute associated with the source content item and the at least one attribute associated with the at least one of a plurality of content items.

17. An apparatus according to claim 15, wherein the processor is further configured to provide for display of a link relation by generating a graphical representation indicative of an association between the source content item and the at least one relevant content item.

18. An apparatus according to claim 17, wherein the processor is further configured to generate a graphical representation by generating at least one of a circular graph, undirected graph, or a matrix arrangement.

19. An apparatus according to claim 15, wherein the processor is further configured to determine a weight of the link relation by determining a weight of the link relation based at least in part on a total number of similar attributes between the source content item and the at least one relevant content item.

20. An apparatus according to claim 15, wherein the processor is further configured to perform an analysis of a link relation by performing an analysis of a link relation in response to receiving a selection of the source content item.

21. An apparatus according to claim 15, wherein the processor is further configured to provide for display of link relations for a plurality of content items wherein each one of the plurality of content items is linked to at least another one of the plurality of content items.

22. An apparatus comprising:
means for performing an analysis of a link relation between a source content item and at least one of a plurality of content items;
means for identifying at least one content item relevant to the source content item, wherein means for identifying at least one content item relevant to the source content item comprises means for identifying a similarity between at least one attribute associated with the source content item and at least one attribute associated with the at least one relevant content item;
means for determining a weight of the link relation based at least in part on the identified similarity; and
means for providing for display of a link relation between the source content item and the identified at least one relevant content item.

23. An apparatus according to claim 22, wherein means for performing an analysis of a link relation comprises means for performing an analysis of link relation in response to receiving a selection of the source content item.
